(19) United States
(12) Patent Application Publication
(10) Pub. No.: US 2021/0341264 A1
(43) Pub. Date: Nov. 4, 2021

(54) OPTICAL SYSTEMS AND DEVICES FOR BALLISTIC PARAMETER MEASUREMENTS

(71) Applicant: SensorMetrix, San Diego, CA (US)

(72) Inventor: Anthony F. Starr, San Diego, CA (US)

(21) Appl. No.: 17/168,907

(22) Filed: Feb. 5, 2021

Related U.S. Application Data
(63) Continuation of application No. PCT/US2019/045371, filed on Aug. 6, 2019.
(60) Provisional application No. 62/715,254, filed on Aug. 6, 2018.

(51) Int. Cl. F41J 5/02; G02B 3/00; G02B 5/12; F41J 5/08; G01V 8/22

(52) U.S. Cl. CPC F41J 5/02; G02B 3/0037; G01V 8/22; F41J 5/08; G02B 5/12

(57) ABSTRACT

A ballistic detection system includes one or more light sources configured to transmit collimated light through a detection area; a receiver array arranged with respect to the detection area to receive the collimated light in multiple side-by-side channels, the receiver array including (i) light detectors corresponding to the multiple side-by-side channels, and (ii) lenses arranged to focus respective portions of the collimated light, which has transited the detection area, onto respective ones of the light detectors corresponding to the multiple side-by-side channels; and a ballistics analysis computer coupled with the receiver array and programmed to identify a location of a projectile that passes through the detection area by performing ratiometric comparison of signal data from the light detectors, the signal data corresponding to fractional blockage, by the projectile, of the collimated light in one or more of the multiple side-by-side channels.

### CROSS-REFERENCE TO RELATED APPLICATIONS

This application is a continuation of PCT Application No. PCT/US2019/045371, filed on Aug. 6, 2019, which claims priority to U.S. Provisional Application No. 62/715,254, filed on Aug. 6, 2018, which are incorporated by reference herein.

### STATEMENT AS TO FEDERALLY SPONSORED RESEARCH

This invention was made with government support under contract numbers W900KK-15-C-0032 and W900KK-16-C-0033 awarded by the U.S. Army Contracting Command, Charlie Division. The government has certain rights in the invention.

### BACKGROUND

This specification relates to measurements of ballistic parameters of munitions, including the measurement of location of the moving munition arrival on a defined virtual surface or region of space, the munition's trajectory, velocity, and/or its caliber.

The US Army provides the world's most realistic training and testing solutions for the U.S. Department of Defense. Part of that effort includes the use of live fire training of many types of weapons from small arms to larger ground and vehicle launched munitions. An important aspect of assessing the training exercises is the determining the location of ballistic penetration or point of impact (POI) of the munitions. Assessment is further enhanced if other ballistic parameters, such as the caliber and velocity, can be determined as well.

### SUMMARY

The present disclosure relates to optical systems and devices for ballistic parameter measurements. The systems and techniques detailed in this disclosure can provide a non-contact method of making such measurements, where no contact of the munition with a target or other physical object is necessary for the measurement to be made. In general, innovative aspects of the technologies described herein can be implemented in one or more of the following embodiments of a ballistic detection system.

In a first embodiment, a ballistic detection system includes one or more light sources configured to transmit collimated light through a detection area; a receiver array arranged with respect to the detection area to receive the collimated light in multiple side-by-side channels, the receiver array including (i) light detectors corresponding to the multiple side-by-side channels, and (ii) lenses arranged to focus respective portions of the collimated light, which has transited the detection area, onto respective ones of the light detectors corresponding to the multiple side-by-side channels; and a ballistics analysis computer coupled with the receiver array and programmed to identify a location of a projectile that passes through the detection area by performing ratiometric comparison of signal data from the light detectors, the signal data corresponding to fractional blockage, by the projectile, of the collimated light in one or more of the multiple side-by-side channels.

The foregoing and other embodiments can each optionally include one or more of the following features, alone or in combination.

In a second embodiment according to the first embodiment, the lenses include a single monolithic lens array.

In a third embodiment according to the second embodiment, the single monolithic lens array is formed using molded plastic.

In a fourth embodiment according to any of the first through third embodiments, the one or more light sources include a transmitter array including multiple light emitters, and the transmitter array is configured to transmit the collimated light as a set of multiple collimated light beams.

In a fifth embodiment according to the fourth embodiment, the ballistic detection system includes a one-to-one correspondence between the light emitters and the light detectors.

In a sixth embodiment according to the fifth embodiment, the light emitters include narrowband or monochromatic light emitters including two or more separate wavelength bands or colors, and each of the light detectors has an associated narrow passband filter in front of the light detector that restricts sensitivity of the light detector to the narrowband or monochromatic light produced by that light detector's corresponding light emitter, which reduces sensitivity to other light sources such as sunlight.

In a seventh embodiment according to the sixth embodiment, each of the light emitters includes a near infrared (NIR) light emitting diode (LED), or a visible LED, or a laser diode. For example, the narrowband or monochromatic light emitters can include GaInN/GaN blue LEDs centered about 470 nm with a range of wavelengths from 405 nm to 540 nm, GaInN/GaN green LEDs centered about 525 nm with a range of wavelengths from 445 nm to 605 nm, and/or AlGaInP/GaAs red LEDs centered about 625 nm with a range of wavelengths from 560 nm to 700 nm, or AlGaInP laser diodes configured to emit narrowband 650 nm light.

In an eighth embodiment according to the sixth embodiment, the light emitters are arranged to alternately direct the multiple collimated light beams into respective ones of two columns that are offset from each other in a direction of the projectile's motion. A width of each of the multiple collimated light beams is greater than a channel-to-channel spacing of the multiple side-by-side channels, thereby causing the side-by-side channels to overlap with each other. Further, the light detectors are alternately positioned in respective ones of the two columns, and the ballistics analysis computer is programmed to identify the location of the projectile that passes through the detection area by performing ratiometric comparison of the signal data corresponding to fractional blockage, by the projectile, of the collimated light in two or more of the multiple side-by-side channels.

In a ninth embodiment according to any of the fourth through eighth embodiments, the transmitter array is configured to generate the multiple collimated light beams in the multiple side-by-side channels with different combinations of wavelength and polarization to isolate the multiple side-by-side channels from each other, reduce any cross-talk between channels, and reduce sensitivity to any ambient sources.

In a tenth embodiment according to any of the fourth through ninth embodiments, the transmitter array is configured to generate the multiple collimated light beams in the multiple side-by-side channels using different modulation phase and/or frequency modulation techniques to isolate the channels from cross-talk between channels.

In an eleventh embodiment according to any one of the preceding embodiments, each of the one or more light sources is a pulsed light source that is triggered by a projectile detector, and the projectile detector is configured to provide wide field of view detection of the projectile, initiate time-of-flight measurement, and trigger the pulsed light sources.

In a twelfth embodiment according to the eleventh embodiment, the projectile detector includes a conventional ballistic chronograph. Further, in one or more embodiments, the projectile detector include an oblique angle ballistic chronograph as described below.

In a thirteenth embodiment according to any one of the preceding embodiments, (i) the detection area is a first detection area, (ii) the ballistic detection system includes a retroreflector configured and arranged to fold the multiple collimated light beams back onto a parallel but offset path, thereby forming a second detection area offset from the first detection area along a direction of travel of the projectile, and (iii) the ballistics analysis computer is programmed to determine a magnitude and direction of a velocity vector of the projectile, the velocity magnitude determined by measuring a time offset between a pair of modulations in the signal data, and the velocity direction by measuring a relative size of the modulations of the pair.

In a fourteenth embodiment according to the thirteenth embodiment, the retroreflector includes a corner reflector that includes two reflecting surfaces with surfaces at right angles to each other.

In a fifteenth embodiment according to any one of the preceding embodiments, the ballistic detection system includes a set of filters configured to tailor an intensity profile of the collimated light in at least a portion of the multiple side-by-side channels.

In a sixteenth embodiment according to the thirteenth, fourteenth or fifteenth embodiments, the ballistics analysis computer is programmed to determine the velocity magnitude by dividing an actual distance traveled by the time offset, wherein the actual distance traveled is a perpendicular spacing between the first and second detection areas divided by cosine of an angle of the velocity direction. Thus, the ballistics analysis computer becomes an oblique angle ballistic chronograph. In addition, any of the systems and techniques described in this application (as well as other systems and techniques) usable to measure the time-of-flight between two planes and calculate the trajectory of the munition between the planes can be used to build an oblique angle ballistic chronograph that measures the velocity of munitions traveling at oblique angles in accordance with the sixteenth embodiment.

In a seventeenth embodiment according to any of the thirteenth through sixteenth embodiments, the one or more light sources include a transmitter array including narrowband or monochromatic light emitters including two or more separate wavelength bands or colors, each of the light detectors has an associated narrow passband filter in front of the light detector that restricts sensitivity of the light detector to the narrowband or monochromatic light produced by that light detector's light emitter, the transmitter array is configured to transmit the collimated light as a set of multiple collimated light beams, the light emitters are arranged to alternately direct the multiple collimated light beams into respective ones of two columns that are offset from each other in a direction of the projectile's motion in the first detection area, wherein a width of each of the multiple collimated light beams is greater than a channel-to-channel spacing of the multiple side-by-side channels, thereby causing the side-by-side channels to overlap with each other, the light detectors are alternately positioned in respective ones of two corresponding columns in the second detection area offset from the first detection, and the ballistics analysis computer is programmed to identify the location of the projectile that passes through the first and second detection areas by performing ratiometric comparison of the signal data corresponding to fractional blockage, by the projectile, of the collimated light in two or more of the multiple side-by-side channels. Further, each of the light emitters can include a near infrared (NIR) light emitting diode (LED), or a visible LED, or a laser diode. For example, the narrowband or monochromatic light emitters can include GaInN/GaN blue LEDs centered about 470 nm with a range of wavelengths from 405 nm to 540 nm, GaInN/GaN green LEDs centered about 525 nm with a range of wavelengths from 445 nm to 605 nm, and/or AlGaInP/GaAs red LEDs centered about 625 nm with a range of wavelengths from 560 nm to 700 nm, or AlGaInP laser diodes configured to emit narrowband 650 nm light.

In an eighteenth embodiment according to any one of the preceding embodiments, the one or more light sources include (i) a first light source configured to transmit the collimated light as first collimated light through the detection area along a first direction, and (ii) a second light source configured to transmit second collimated light through the detection area along a second direction. Further, in the thirteenth embodiment, the first direction crosses the second direction. Furthermore, in the thirteenth embodiment, the first direction crosses the second direction. Also, in the thirteenth embodiment, the receiver array is a first receiver array, the multiple side-by-side channels are first multiple side-by-side channels, and the ballistic detection system includes a second receiver array arranged with respect to the detection area to receive the second collimated light in multiple second side-by-side channels, the second receiver array including (i) light detectors corresponding to the multiple second side-by-side channels, and (ii) lenses arranged to focus respective portions of the second collimated light, which has transited the detection area, onto respective ones of the light detectors corresponding to the multiple second side-by-side channels. Additionally, in the thirteenth embodiment, the ballistics analysis computer is coupled with the second receiver array and is programmed to identify the location of the projectile as both an X position and a Y position of the projectile in the detection area.

In a nineteenth embodiment according to the eighteenth embodiment, the first light source and the first receiver array are co-sited in an electro-optic housing located on a first side of a target, and a second light source and the second receiver array are co-sited in an electro-optic housing located on a second side of the target, and the ballistic detection system includes a first retroreflector located on a third side of the target opposite the first side and a second retroreflector located on a fourth side of the target opposite the second side.

In a twentieth embodiment according to the nineteenth embodiment, the first light source, the second light source, the first receiver array, and the second receiver array are all co-sited in an electro-optic housing located on a first side of a target, and the ballistic detection system includes a retroreflector located on a second side of the target, opposite the first side.

In a twenty-first embodiment according to the thirteenth embodiment, the nineteenth embodiment, or the twentieth embodiment, the retroreflector includes microbeads arranged to provide a retroreflection cone angle.

In a twenty-second embodiment according to the twenty-first embodiment, the microbeads are glass microspheres dispersed on a black surface of the retroreflector.

In a twenty-third embodiment according to the thirteenth embodiment, the nineteenth embodiment, or the twentieth embodiment, the retroreflector includes pyramidal retroreflectors formed of arrays of 3D corner reflectors.

In a twenty-fourth embodiment according to any one of the preceding embodiments, the target is a pop-up target located in a ground trench, and the electro-optic housing is located in the ground trench.

In a twenty-fifth embodiment according to any of the eighteenth through twentieth embodiments, the first light source includes a first transmitter array including narrowband or monochromatic light emitters including two or more separate wavelength bands or colors, the second light source includes a second transmitter array including narrowband or monochromatic light emitters including the two or more separate wavelength bands or colors, each of the light detectors has an associated narrow passband filter in front of the light detector that restricts sensitivity of the light detector to the narrowband or monochromatic light produced by that light detector's light emitter, the first transmitter array is configured to transmit a first set of multiple collimated light beams in respective ones of two columns that are offset from each other in a direction of the projectile's motion, the second transmitter array is configured to transmit a second set of multiple collimated light beams in respective ones of two columns that are offset from each other in the direction of the projectile's motion, wherein a width of each of the multiple collimated light beams is greater than a channel-to-channel spacing, thereby causing the side-by-side channels to overlap with each other, the light detectors are alternately positioned in respective ones of two columns, and the ballistics analysis computer is programmed to identify the location of the projectile as both the X position and the Y position of the projectile in the detection area by performing ratiometric comparison of the signal data corresponding to fractional blockage, by the projectile, of the collimated light in four or more of the multiple side-by-side channels. Further, each of the light emitters can include a near infrared (NIR) light emitting diode (LED), or a visible LED, or a laser diode. For example, the narrowband or monochromatic light emitters can include GaInN/GaN blue LEDs centered about 470 nm with a range of wavelengths from 405 nm to 540 nm, GaInN/GaN green LEDs centered about 525 nm with a range of wavelengths from 445 nm to 605 nm, and/or AlGaInP/GaAs red LEDS centered about 625 nm with a range of wavelengths from 560 nm to 700 nm, or AlGaInP laser diodes configured to emit narrowband 650 nm light.

The details of one or more implementations of the technologies described herein are set forth in the accompanying drawings and the description below. Other features, aspects, and advantages of the disclosed technologies will become apparent from the description, the drawings, and the claims.

### BRIEF DESCRIPTION OF DRAWINGS

FIGS. 1A-1B show an example of a ballistic detection system used to detect projectiles directed to a target.

FIG. 1C shows another example of a ballistic detection system.

FIG. 2A shows yet another example of a ballistic detection system having multiple light channels, each channel with its own collimated light source and detector.

FIG. 2B shows yet another example of a ballistic detection system having a single collimated light source used by multiple light channels, each channel with its own detector.

FIG. 3 shows an example of an optical channel of the ballistic detection system of FIG. 1A.

FIG. 4A is schematic representation of an experimental arrangement used to test a NIR optical channel of a ballistic detection system.

FIG. 4B shows a projectile used for the tests.

FIGS. 5A-5B show results of a test designed to measure detection sensitivity of the disclosed ballistic detection systems.

FIGS. 6A-6D show aspects of reflectors used to reflect a collimated beam transmitted by a transmitter of the disclosed ballistic detection systems.

FIGS. 6E-6F show results of measurements of a microsphere retroreflector.

FIG. 7 shows an example of a multi-traverse beam ballistic detection system.

FIG. 8 is an oscilloscope trace of an optical beam signal from a projectile passing through a double traverse beam.

FIG. 9 is a chart showing comparison of the velocities of a set of shots measured in the manner described herein and by a commercial chronograph with a 12″ gage length.

FIG. 10 shows modulation depth versus virtual point of impact.

FIG. 11 shows the projectile's trajectory tilted by an angle with respect to the beams of the multi-traverse beam ballistic detection system of FIG. 7.

FIG. 12 shows an example of a signal detected when the projectile transits each beam at different relative levels.

FIG. 13 shows two sets of modulation curves for a series of shots fired using the rifle angle shown in FIG. 11.

FIG. 14 shows an example of a geometrical arrangement of the multiple light channels of the ballistic detection system shown in FIG. 2A.

Reference numbers and designations in the various drawings indicate exemplary aspects, and/or implementations of particular features of the present disclosure.

### DETAILED DESCRIPTION

Real-time detection of ballistic penetration allows immediate feedback into the training scenario, including automated reactions based on valid hits. The target sizes can range from less than one meter to over 10 meters in size. The targets may not be stationary during the training exercise. In some cases, the “target” may be an opening such as a window. The incoming direction of munitions can vary during training scenarios, and can include top down attack directions. It is desirable to provide a modular, portable, and scalable detection capability so that detection fields may be readily assembled that not only vary in size, but can be made to surround a 3D target volume. The projectiles to be detected range from 5.56 mm caliber (diameter) to much larger caliber weapons. The velocities involved can include subsonic, transonic, and supersonic.

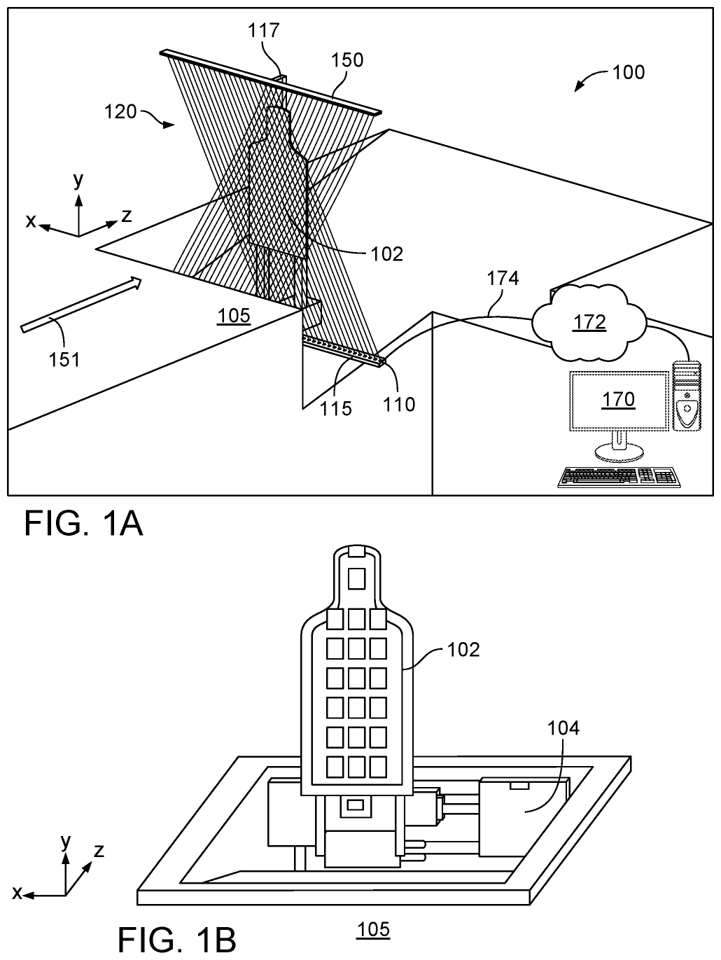

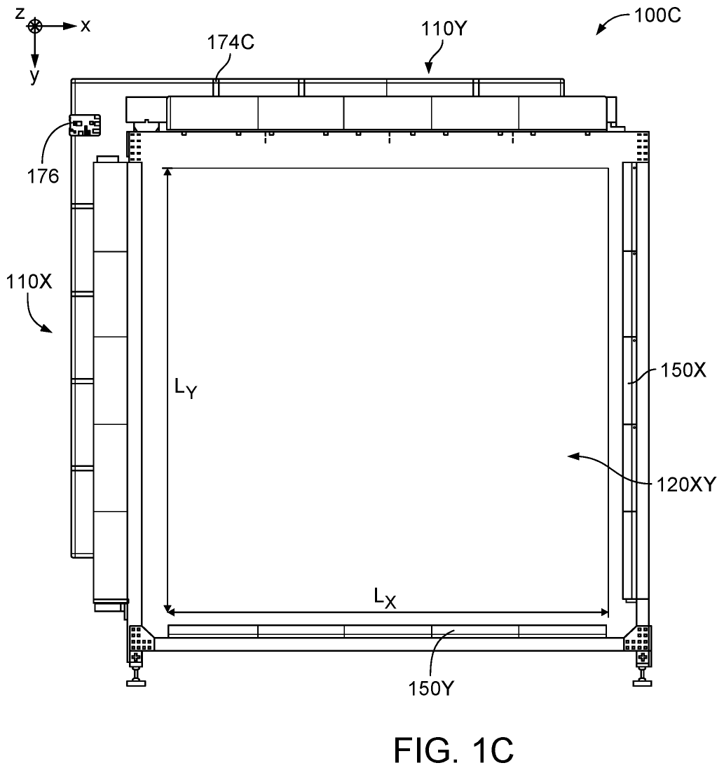

FIG. 1A is a cutaway view of an example implementation of a ballistic detection system 100 that uses a multi-beam optical detection concept. FIG. 1B shows a pop-up target 102 that is located in a ground trench 104 and can be equipped with the ballistic detection system 100. In this example, the ballistic detection system 100 includes electro-optic transceiver array(s) 110 and a retroreflector 150. The electro-optic transceiver array(s) 110 are arranged and configured to emit and receive multiple parallel side-by-side optical beams (channels) 120 in a crossed linear configuration, e.g., in the (x,y)-plane. The beams 120 are collimated, as described below, and are used to detect the passage, e.g., along a firing direction 151, here parallel to the z-axis, of a projectile from centimeters in front of the target 102, or could be used in the absence of a target altogether. The crossed arrays of beams 120 allow pinpointing the location of the projectile on a 2D surface, e.g., on the (x,y)-plane. The beam transmitters and receivers 110 are co-sited in an electro-optic housing 115, shown below ground 105. A low-cost retroreflector 150 on the opposite (above) side of the target 102, as shown in FIG. 1A, reflects the collimated beams 120 and allows high SNR (signal-to-noise-ratio) detection based on projectile opacity rather than scattering characteristics.

The ballistic detection system 100 also includes a ballistics analysis computer 170 communicatively coupled with the transceiver array 110 through a communication link 174. The communication link 174 can be a direct, wire link, or can be implemented through a network 172. As described in detail below, the ballistics analysis computer 170 is programmed to identify a location of a projectile that passes through a detection area, e.g., in front of the target 102, by performing ratiometric comparison of signal data from light detectors of the transceiver array 110.

The ballistic detection system 100 is configured to standalone and to not rely on external triggers to detect projectiles. It is of course desired that the ballistic detection system 100 has high probability of detection along with high precision location of projectile intersection with the detection area, and should also demonstrate low false positives.

The ballistic detection system 100 is configured to track multiple engagements, e.g., multiple incoming projectiles, and support a rate of fire of at least 10 events/second. Because live fire can damage exposed equipment, the ballistic detection system 100 is designed to be concealable in safe locations. Moreover, the ballistic detection system 100 can be used in certain scenarios, in which it is desired that the target system not indicate positions of possible targets. Note that the retroreflector 150 can be low cost in relation to other components of the ballistic detection system 100, so there is less need to conceal the retroreflector(s) 150 in safe locations.

FIG. 1C shows another example of a ballistic detection system 100C with arrays of beams 120XY that are orthogonally crossed to allow pinpointing a location of a projectile on a 2D surface, e.g., as an (x,y)-point on the (x,y)-plane. In this example, the ballistic detection system 100C includes a first electro-optic transceiver array 110X arranged to emit a first subset of the beams 120XY that propagate along the x-axis, and its corresponding retroreflector 150X that is arranged to return the beams of the first subset along the x-axis back to the first electro-optic transceiver array 110X. Additionally, the ballistic detection system 100C includes a second electro-optic transceiver array 110Y arranged to emit a second subset of the beams 120XY that propagate along the y-axis, and its corresponding retroreflector 150Y that is arranged to return the beams of the second subset along the y-axis back to the second electro-optic transceiver array 110Y. Each of the electro-optic transceiver arrays 110X, 110Y is formed from multiple modules, e.g., 2, 3, 6, 8, 9 or more modules, so it can extend over a desired length L_{X}, L_{Y}, respectively. The lengths L_{X}, L_{Y} can be 0.5, 0.75, 1.5, 2, 2.5 m, or more. Additional modules added along one or both x- and y-axes would easily extend the target region as needed.

The ballistic detection system 100C can be placed in front (e.g., along the z-axis) of a target 102, e.g., a paper, E- or F-type metallic silhouette or other targets, that serves as the point of aim for small caliber live fire. The applications include training, weapon zeroing, or other scoring/evaluation opportunities. The ballistic detection system 100C auto detects rounds passing through the beams 120XY, locates and tracks their positions. A controller 176 of the ballistic detection system 100C can provide real-time 6D kinematic data, e.g., position and vector velocity, on the detected round. The data can be (effectively) instantly made available through a communication link 174C to any attached networked system. For demonstration purposes, a MIMO WiFi system provided data to shooting positions more than 1000 meters up-range.

The ballistic detection system 100C was tested, and it performed as showed in Table 1.

TABLE 1

| Performance metric | System 100C performance | Comments |
|---|---|---|
| Point of Impact location | <2.4 mm | |
| precision | positional error | |
| Velocity | <2% error | |
| Caliber determination | Yes | Caliber selected from discrete |
| | (>98% correct) | list of choices |
| Sensitivity to super-, trans-, | Yes | |
| and subsonic | | |
| Rate of fire | 24 rps | Max ROF available |
| Probability of Detection | >97% | No false positives |
| Trigger method | Auto trigger | |
| Network compatibility | Ethernet, WiFi, Bluetooth, | |
| | Serial, USB | |
| Trajectory | Demonstrated with 2° | Incoming elevation and |
| | precision | azimuth angles |
| TRL at program exit | TRL-6+ | |

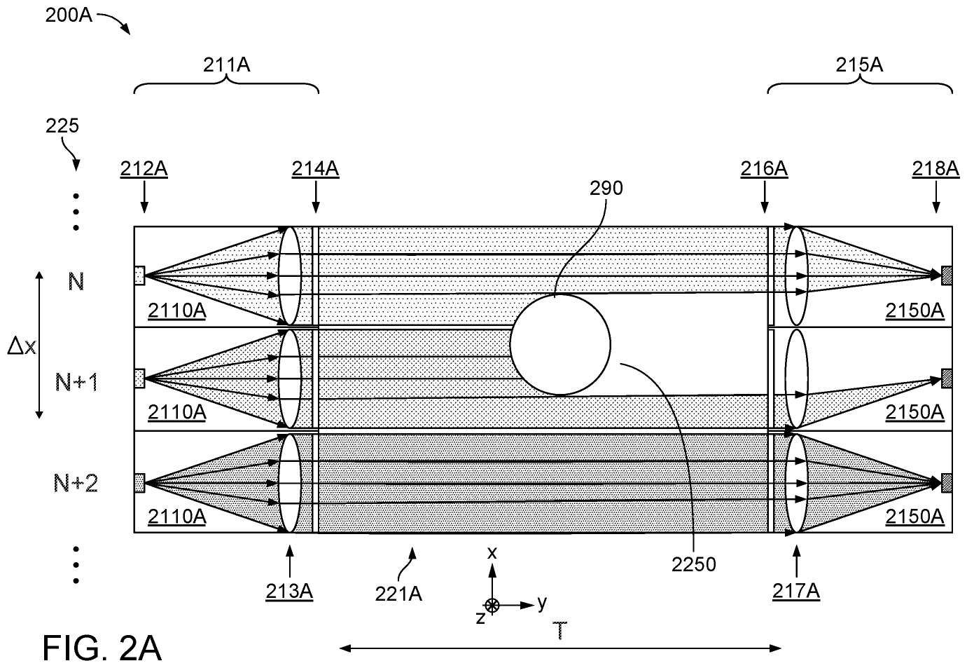

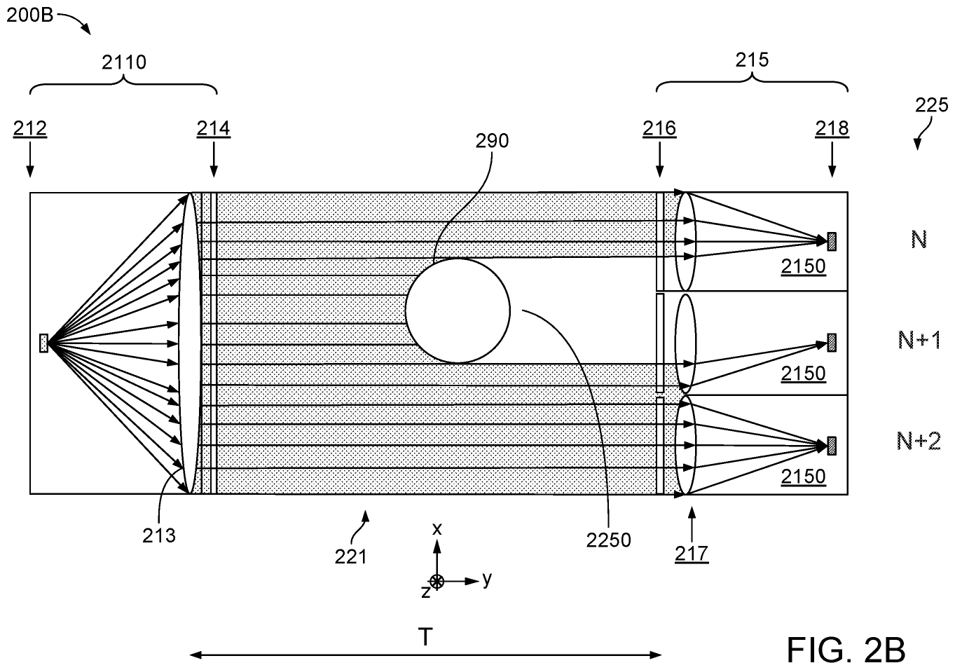

FIGS. 2A and 2B are simplified representations of example implementations of a ballistic detection system 200A and 200B, respectively. Although only three adjacent optical channels 225 (N, N+1, N+2) are shown, it is expected that a single module of the ballistic detection system 200A/200B can have M channels, where M can be from 16 to 64, for instance. Other numbers of channels are also possible.

Referring now to FIG. 2A, the ballistic detection system 200A includes a transmitter array 211A and a receiver array 215A. The transmitter array 211A includes M transmitters (TXs) 2110A. In the example shown in FIG. 2A, each transmitter (TX) 2110A includes a light source 212A, a collimator 213A, and a spatial/spectral/polarization filter 214A. The receiver array 215A includes M receivers (RXs) 2150A. In the example shown in FIG. 2A, each receiver (RX) 2150A includes a detector 218A, a spatial/spectral/polarization filter 216A, and a collimator 217A. In this manner, each receiver 2150A is paired with a single transmitter 2110A to receive a corresponding one of M collimated beams 221A. In the example illustrated in FIG. 2A, each channel 225 uses a transmitter 2110A in which the light source 212A can be a Near Infrared (NIR) LED, and a receiver 2150A in which the detector 218A can be a photodiode. The TXs' collimators 213A and the RXs' collimators 217A, also referred to as TX and RX optics, are co-collimated to provide a higher signal-to-noise ratios than other beam scattering methods such as backscatter. Each of the three adjacent optical channels 225 (or each set of four or more adjacent optical channels in the M channels, or each of the M channels) can operate at a unique combination of wavelength, polarization, and time/frequency domain modulation (or a unique combination of two of the foregoing optical channel characteristics, or a unique on of the foregoing optical channel characteristics). These techniques provide channel isolation. Here, a beam traverse distance T can be 0.5, 1, 3, or 5 meters or up to 10 meters or more. Although not explicitly shown in FIG. 2A, the ballistic detection system 200A includes a ballistics analysis computer, e.g., the ballistics analysis computer 170, communicatively coupled with the detectors 218A of the receiver array 215A. The ballistics analysis computer is programmed to identify a location of the projectile 290 that passes through the detection area by performing ratiometric comparison of signal data from the detectors 218A, the signal data corresponding to fractional blockage 2250, by the projectile 290, of the collimated light 221A in one or more of the multiple side-by-side channels 225.

Referring now to FIG. 2B, the ballistic detection system 200B includes a single transmitter 2110 and a receiver array 215. The transmitter (TX) 2110 includes a light source 212, a collimator 213, and a spatial/spectral/polarization filter 214. Here, the light source 212 can be a NIR LED. The receiver array 215 includes M receivers (RXs) 2150. In the example shown in FIG. 2B, each receiver (RX) 2150 includes a detector 218, a spatial/spectral/polarization filter 216, and a collimator 217. Here, the detector 218 can be a photodiode. In this example, a single transmitter 2110 is used to illuminate M receivers 2150 with collimated light 221. Here, the collimated light 221 can traverse a distance T of 0.5, 1, 3, or 5 meters or up to 10 meters or more. So long as the light 221 is collimated, the detection scheme of the ballistic detection system 200B will work the same way as the ballistic detection system 200A. Collimated light is light in which the rays are parallel. A small (point) source 212 of light focused to infinity is collimated. Ideal collimated light 221 does not diverge. In general, a single source 212 can illuminate any number of detectors 2150, limited only by the ability to produce such a broad collimated source, e.g., using the single collimator 213. Although not explicitly shown in FIG. 2B, the ballistic detection system 200B includes a ballistics analysis computer, e.g., the ballistics analysis computer 170, communicatively coupled with the detectors 218 of the receiver array 215. The ballistics analysis computer is programmed to identify a location of the projectile 290 that passes through the detection area by performing ratiometric comparison of signal data from the detectors 218, the signal data corresponding to fractional blockage 2250, by the projectile 290, of the collimated light 221 in one or more of the multiple side-by-side channels 225.

The ballistic detection systems 100, 200A, 200B can be configured to be compatible with conventional communication networks, e.g., network 172, including wireless, cabled, or fiber optic and including networks specifically used at shooting ranges such as the U.S. Army's Future Army System of Integrated Targets (FASIT). Because, the training exercises can be expected to take place in a variety of weather environments, the ballistic detection systems 100, 200A, 200B can be configured for use under a variety of weather environments. For instance, the ballistic detection systems 100, 200A, 200B can be configured with light sources 212A, 212 that emit ultraviolet, visible, or infrared light, which can meet the requirements stated above.

Referring again to FIG. 1, the ballistic detection system 100 can be constructed using modular units, where each unit can be between 20 and 75 cm in length, e.g., along the x-axis, and containing, for instance, 16 to 64 optical channels (Rx/TX modules). These can be assembled end-end to build larger arrays 110. At least two crossed linear arrays can be used to form a detection field that provides 2D point of impact information.

In summary, one or more of the ballistic detection systems 100, 200A, 200B can incorporate a number of elements:
The ballistic detection system 100 utilizes one or more crossed linear arrays 110 of adjacent optical detection channels 120. For example, when two crossed arrays 110 are used, each array 110 locates a projectile, e.g., the projectile 290, along a respective 1D axis: a first one of the arrays 110 locates the projectile 290 along the x-axis, and a second one of the arrays 110 locates the projectile 290 along the y-axis; in combination the two arrays 110 uniquely locate the projectile on a 2D surface, e.g., in the (x,y)-plane. The 2D detection surface can be located immediately in front of any desired target, e.g., 102.
A pulsed active illumination source 212A or 212 can be used. Such a pulsed active illumination source is triggered by a projectile detector. The projectile detector can be implemented as a conventional ballistic chronograph. The approximate pulse duration can be ˜150 μsec (e.g., greater than the transit time for slowest moving projectiles 290). The short duration pulse provides several advantages: 1) ensures a high SNR during a point-of-interest (POI) measurement, 2) eliminates continuous emissions (that might induce artifacts into night vision equipment), 3) allows utilization of low cost (˜$0.60 each), lower continuous power sources 212A/212, such as LEDs.
The 1D arrays 110 of TX/RX pairs have tightly co-collimated beam patterns. Further, they are tailored with spatial filters, e.g., 214A/214 and 216A/216 to provide approximately uniform transverse intensity (total intensity integrated in downrange direction, e.g., along the z-axis vs. position along array direction, e.g., along the x-axis. Combined with analog-to-digital measurements of channels, e.g., channels 225, ratiometric analysis of signals provides location with precision significantly better than channel-channel spacing Δx and is independent of caliber, velocity, and projectile length.
The ballistic detection systems 100, 200A, 200B can be configured for multiple modes of operation: 1) point-point detection where TXs 2110A project light 221A directly into RXs 2150A elements, or 2) utilize a retroreflector 150 so that the TX/RX modules 110 may be co-sited on the same side of the detection field.
A second, low-level active illumination TX/RX system provides wide FOV detection capability. The second system 1) serves to initiate time-of-flight measurement (to determine projectile 290 velocity), and 2) serves as a trigger for the precision locating multi-beam system 100, 200A, 200B. This second system (very similar to that used by a conventional ballistic chronograph) only detects arrival of projectile 290, not the projectile 290's location.
Time-of-flight delay between planes parallel to the (x,y)-plane provides projectile velocity magnitude measurement.
Optical (visible or non-visible) wavelength and polarization diversity are used to isolate adjacent channels 225 from cross talk, e.g., in the case of the ballistic detection system 200A. In addition, the channels may be isolated by modulation frequency/time domain techniques, e.g., in the case of the ballistic detection system 200B.
The detection electronics are transimpedance amplifiers that feed signals to a peak (minimum or maximum) sample & hold circuits. Upon triggering, A/D converters can measure all the channels 225, and the signals are analyzed to determine the POI. All electronic components used in the system 100, 200A, 200B are COTS (commercial off-the-shelf) leading to low cost implementation.
The sensing module, e.g., 110, 215A/215 is low profile.
   In addition, a custom, single monolithic lens array 213A, 217A/217 can be fabricated using molded or other optical fabrication methods. One monolithic lens per array can be used.

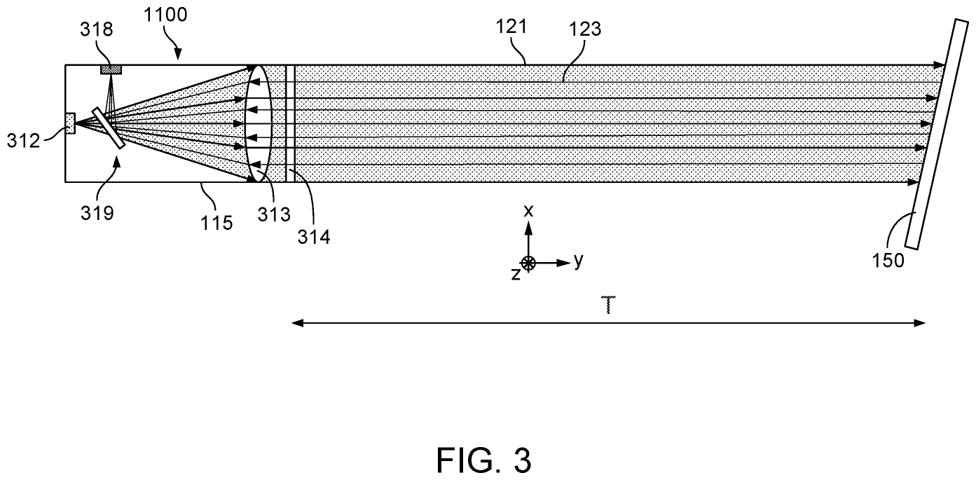

FIG. 3 shows an example of a transceiver module 1100 that is part of the TX/RX array 110 of the ballistic detection systems 100. Here, a TX and a RX are co-sited in the housing 115 along with a beam splitter 319. Here, the TX includes a light source 312, a collimator 313 and a filter 314. The RX includes the same filter 314 and collimator 313, and a detector 318. The beam splitter 319 is arranged and configured to transmit light emitted by the light source 312. A transmitted beam 121 issued by the transmitter TX is retroreflected back as a reflected beam 123 to the receiver RX. The beam splitter is arranged and configured to reflect the reflected light to the detector 318. By using a retroreflector 150, the positioning/orientation of the element configured to reflect the transmitted beam 121 is not critical (retroreflector 150 is shown intentionally off-normal, e.g., tilted relative to the (x,z)-plane. Here, the ballistic detection system 100 can continue to function effectively even if the incident angle is more than 50° off the surface normal of the retroreflector 150. Here, each of the transmitted beam 121 and reflected beam 123 can traverse a distance T of about 10 meters.

Elements of the detection methodology used by the ballistic detection systems 100, 200A/200B can provide the following technical effects.
POI can be determined with <2.5 mm spatial accuracy across detection areas spanning>10 meters.
Detection of projectiles, e.g., projectile 290, with velocity from subsonic (<100 fps) up to supersonic (>3000 fps) can be carried out with velocity accuracy errors<1%.
Approximate projectile caliber/cross-sectional area determination to better than 10% can be carried out.
A rate-of-fire (ROF) up to 100 rps can be supported.
The modular design of the ballistic detection systems 100, 200A/200B allows integration of multiple detection units to provide 3D target coverage (e.g., include detection of top-down trajectories).
Each of the ballistic detection systems 100, 200A/200B is readily integrated into conventional range network systems.

### Technical Approach

Referring again to FIG. 1, the ballistic detection system 100 uses crossed linear arrays 110, each using high numbers of highly collimated optical beams 120 used to detect and precisely locate the passage of projectiles, e.g., projectile 290, through a 2D area defined by the overlap of the two sets of the crossed beams 120.

Several innovative elements can enable the proposed approach. These include:
Linear arrays 110 using adjacent, collimated TX/RX optical beams 120 (e.g., 121, 123, respectively), each beam with a uniform transverse intensity profile such that analog measurement of the peak beam blockage parameter can allow location determination with a precision significantly less than the width of the beam. An individual channel module, e.g., 1100, can be ½″×½″×1″ (along an optical axis thereof). The overall length, e.g., along the x-axis, can depend on the application, but should be commensurate with the target area to be monitored.
A secondary, wide beam passive detection plane, located inches in front (along the z-axis) of the arrays 110, can serve to detect incoming rounds, e.g., projectile 290, and can trigger the other detection plane, in which the beams 120 are contained.
Alternatively, triggering can be accomplished by the detection array(s) 110 themselves by incorporating a circuit that detects high positive or negative signal derivatives which in turn initiates measurement of the signal levels. By incorporating a sample and hold peak (min or max) circuit, the measurement can be initiated with adequate delay to ensure full intrusion of the projectile through the detection area.

Firstly, each of the collimated beams 120, 121, 123, 221A, 221 or channel 225, can detect the optical blockage 2250 of the projectile 290 (due to its opacity) as it passes, e.g., along the z-axis, through the plane defined by the collimated beams. Formally, this is the forward scattering (e.g., reduction of the main beam). When an electromagnetic wave 221A, 221 interacts with any object, e.g., projectile 290, that wave may be scattered and/or absorbed. Although one may choose to detect the oblique or back-scattering waves, those quantities are strongly dependent upon the projectiles surface properties, and those signals are generally weaker. In contrast, detection of the projectile's opacity is highly reliable and provides the highest signal, and hence SNR ratio measurement.

Secondly, it is proposed to perform analog measurements of the channels to obtain fractional blockage 2250 of each channel 225 during an event. Each optical beam can have lateral dimensions not much larger than the smallest caliber projectile to be detected. Furthermore, a gray scale spatial filter 216A/216/314 in each channel 225 can be used that produce optical beams with nearly uniform lateral power density across the extent (transverse to projectile direction, e.g., along the z-axis) of the beam, e.g., along the x-axis.

With the transverse intensity of each beam controlled in this way, the location of a projectile can be determined with a POI precision that is less than the width of the optical beam 221A, 221. Referring to FIGS. 2A and 2B, it is apparent that, in general, a projectile 290 may only fractionally block light in a given channel 225, and furthermore, can partially block two adjacent channels 225. By proper choice of geometry, one can ensure that at least two channels 225 always detect intensity changes. The location, e.g., along the x-axis, of the projectile 290 can be determined by a ratiometric comparison of the blockage 2250 of the channels 225.

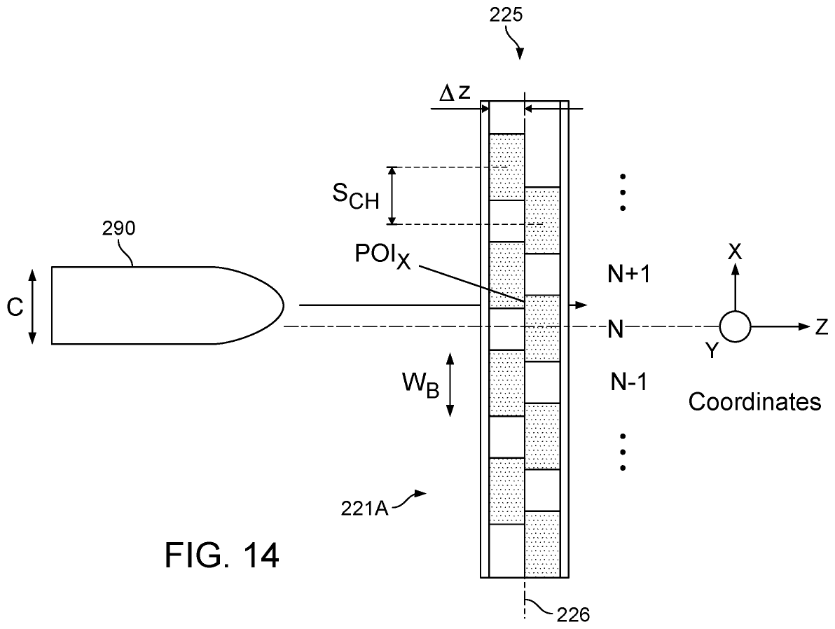

An example of such a geometry for arranging the channels 225 of the ballistic detection system 200A is illustrated in FIG. 14. Here, the collimated beams 221A, which correspond to the channels 225 and define the measurement reference plane 226, e.g., parallel to the (x,y)-plane, are offset, in an alternating manner, by a lateral offset Δz along a direction normal to the measurement reference plane 226. I.e., every other channel 225 is offset relative to the measurement reference plane 226 by the lateral offset Δz. The lateral offset Δz is equal to, or larger than, the size of the collimated beams 221A along a normal to the measurement reference plane 226. The nominal lateral offset Δz is anticipated to be ˜3 mm if used in the ballistic detection system 200A. For ballistic detection systems corresponding to larger target areas, larger spacing and beam widths will be used.

By using the geometry shown in FIG. 14, adjacent channels 225 can be spaced within the measurement reference plane 226 by a channel spacing S_{CH} that is smaller than the size (width) W_{B} of the collimated beams 221A within the measurement reference plane 226. In the example shown in FIG. 14, the size W_{B} is measured along the x-axis. This “two-column” arrangement of the collimated beams 221A enables the beam width W_{B} to be greater than the channel spacing SCH to allow overlap of adjacent channels 225 along the x-axis, which in turn enables fabrication of compact optical beam hardware. For instance, to achieve the beam geometry illustrated in FIG. 14, the transmitters 2110A of the transmitter array 211A, and the corresponding receivers 2150A of the receiver array 215A are disposed based on a geometry corresponding to the one illustrated in FIG. 14. When the geometry shown in FIG. 14 is used for the channels 225 of the ballistic detection system 200A, the point of impact POI_{X} and the caliber C of a projectile 290 that passes through the collimated beams 226 can be determined with a resolution smaller than the channel spacing S_{CH}.

Referring again to FIGS. 1A and 1C, it is proposed to utilize a simple and inexpensive retroreflector 150, 150X, 150Y to return the optical beams 120, 120XY to their point or origin for detection. For instance, in FIG. 1A, with the main opto-electronics located in a safe position (e.g., below ground level 105), the retroflectors 150 are placed on the far side of the target 102 (e.g., above the ground, along the y-axis). The retroreflectors 150 are low profile flat plates, likely attached to the target 102, e.g., through a support 117, so as to be brought into position with the appearance of the target 102. In the example illustrated in FIGS. 1 and 3, the retroreflector 150's structure may be wood, metal, or plastic plates roughly ½″ thick (this edge thickness is presented to the shooter), roughly 6″ width (depth), and somewhat wider than the target 102. The surface facing the electro-optics 110, 1100 is retroreflective.

The use of a retroreflector 150 in the ballistic detection system 100 can have several significant benefits. It can be low cost and easily replaced if struck by errant shots. It can have a low profile as presented to the shooter to eliminate distraction. It is lightweight so that it can be attached to a moving target 102, e.g., through a support 117, as illustrated in FIG. 1. When the target 102 is actuated, the retroreflector 150 is simultaneously brought into its prescribed position. By its nature, a retroreflector 150 can exhibit low signal variation in response to small movement by the retroreflector 150.

The ballistic detection systems 100, 200A, 200B can also use a secondary optical detection system (e.g., similar to a conventional ballistic chronograph) which senses passage, along the z-axis, of the projectile 290 several inches (5-10 cm), along the z-axis, in front of the main optical detection system. Upon detection of a projectile 290, the primary detection system 100, 200A, 200B's light source 212A, 212 can be triggered (e.g., pulsed as described above) to enable good SNR and precise projectile locating.

For instance, near infrared LEDs and photodiode pairs are widely used in consumer devices such as remote controls. In these applications they have somewhat limited range, ˜10 meters. Those maximum levels can be increased if pulsed with low duty cycles for short periods (less than 1 msec).
1) The proposed primary optical detection methods, implemented in any one of the ballistic detection systems 100, 200A, 200B as described herein, can achieve the following:
   a) Adequate signal can be detected at ranges of ˜10 m.
   b) The system 100, 200A, 200B can detect the range of munitions anticipated (e.g., using relevant caliber & velocities).
   c) Side-by-side channels 225 can function independently and without interfering with each other.
   d) The optical channels 225 can be made sufficiently immune to ambient effects.
   e) Gray scale filters 214A, 214, 314 can be used to tailor the optical intensity profile as needed.
   f) Retroreflectors 150 can be fabricated and can support the role anticipated for them.
2) A ballistic time-of-flight (TOF) chronographic method can be used. While it is noted that the technique in item 1) above would satisfy the requirements of this item, with the much reduced demands on this triggering system, saving in complexity and cost can be realized.
   a) Wide field of view detection can provide adequate triggering for the primary optical channels 225.
   b) A ballistic time-of-flight (TOF) chronographic system can reliably issue triggers for incoming projectiles.
3) The electronics used to operate the system 100, 200A, 200B can include the following:
   a) Electronics to drive MR LEDs with short pulses.
   b) The total instantaneous power, although short in duration, can be reasonably supplied to all the channels 225. The pulse duration can be long enough to capture the slowest moving projectiles 290.
   c) The detection electronics can be sufficiently fast to capture the highest velocity projectiles 290.
   d) The peak sample & hold circuitry functions adequately, and the analog-digital conversion can take place rapidly and without loss in detection fidelity.
   e) The differential trigger system used on the ballistic TOF sensors can function on various types of ranges, and the trigger latency can be <1 usec.
   f) A rate of fire of at least 10 rnds/sec can be supported.
   g) The electronics portion of the system 100, 200A, 200B can be made modular.
4) Integration of the system can be done as follows:
   a) The detection/location algorithm can be made resilient against the range of caliber and velocities anticipated.
   b) Caliber & projectile velocity can be determined.
   c) Anticipated error rates can be very low.
   d) Network integration can be achieved.

### Single Beam Optical Channel

The basic building block is a transmitter/receiver (Tx/Rx) pair that provides sensitivity to blockage 2250 in a narrow optical detection path. Both transmitter module 2110A, 2110 and receiver module 2150A, 2150 can have optical collimators 213A, 217A, and 213, 217 that give each high gain (narrow angle) beam patterns that are directed at each other (e.g., confocal). The overlap of the beam gain patterns, together with the separation distance T provide the signal and spatial sensitivity of the pair.

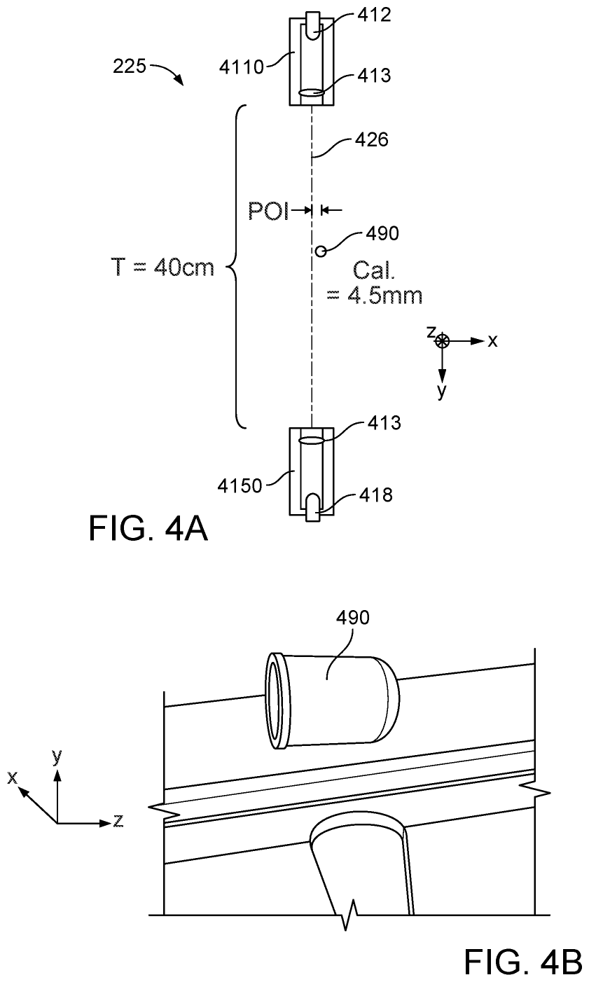

Testing of an optical channel 225 operating at 870 nm in the NIR has been performed as shown in FIGS. 4A-4B. Here, the optical channel 225 includes a TX 4110 and a RX 4150 separated by a distance T=40 cm within a measurement reference plane 426, in this example, parallel to the (y,z)-plane. The TX 4110 includes a NIR LED 412, which here was a Thorlabs 870E operating with 90 mA forward DC current. A simple 10 mm diameter plano-convex lens 413 with a focal length of 20 mm was used as the optical collimator of the TX 4110; the LED-lens distance was therefore 20 mm. The RX 4150 includes a detector 418, which here was an Optek OP999 NIR photodiode. The same type of lens 413 is used as the optical coupler of the RX 4150; the lens-detector distance is again 20 mm. The photodiode was connected in series with a 100 kOhm resistor; it was reverse biased (photoconductive mode) by 6 VDC. The photocurrent was determined by measuring the voltage across the resistor.

It is noted that the optical channel 225 was insensitive to ambient light during the tests. This can be attributed both to the use of narrow NIR as the primary light sensitivity, as well as the use of co-collimated RX 4150/TX 4110 that provide confocal narrow transmit/receive beam profiles.

4.5 mm caliber projectiles 490 were shot at nominal 275 m/s velocity from an air gun fixed in a vice through the 40 cm air gap between the RX module 4150 and TX module 4110. The muzzle-channel distance was 15 cm—therefore, the POI is accurately known and reliably reproduced. The velocity is set by the air reservoir pressure (nominally 2600 psi) and a restrictor screw in the air transfer port. For these tests, the velocity of the 13.4 grain, 6.6 mm long projectile was nominally 900 fps. FIG. 4B shows the projectile 490 used for the tests.

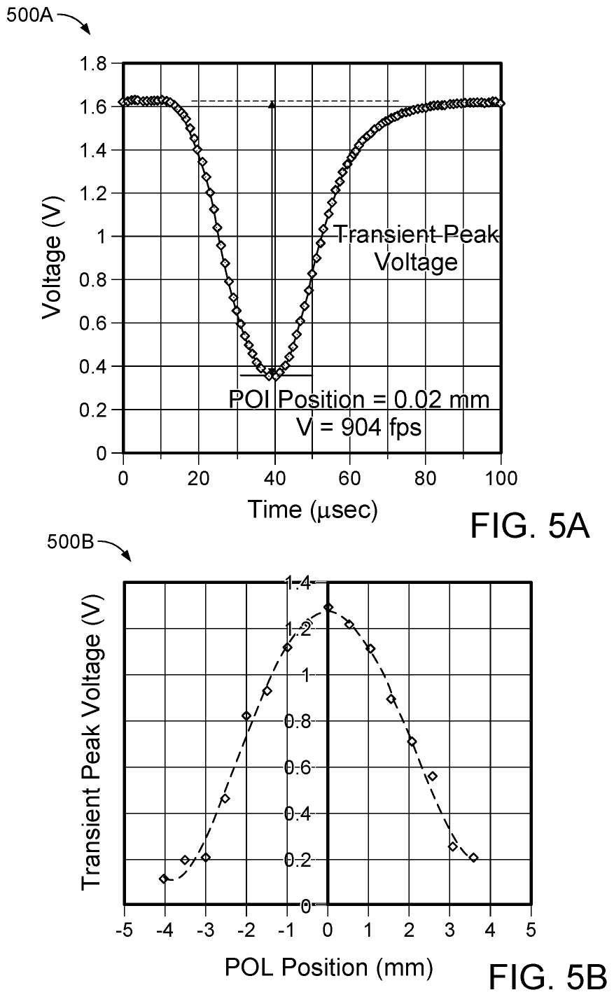

The optical channel 225 was attached to a translation stage which enabled the entire assembly to be translated transverse to the shot direction, e.g., along the x-axis, the POI relative the optical channel is readily controlled. For each POI location, a shot was fired. A chronograph located immediately downrange of the optical channel recorded the shot velocity. A Tektronix oscilloscope triggered on a falling edge and captured the change in voltage (photocurrent) due to the passing projectile. For this test, the peak voltage difference (corresponding to the maximum beam blockage for that POI) was recorded. FIG. 5A is a graph 500A of the optical channel signal acquired on an oscilloscope during the projectile transit ((beam width+projectile length)/velocity)=16 mm/274 m/s=60 usec. The high fidelity of the signal is noted. In FIG. 5A, the measured transient voltage peak is shown for a particular POI location. FIG. 5B is a graph 500B showing the transient peak voltage as a function of projectile lateral POI position. The sensitivity of the optical channel 225 to the projectile lateral position (POI) is clear. It is noted that both the optical channel width and the projectile caliber are smaller than would be used for the Army application. However, it is clear the optical channel 225 provides locating precision substantially better than the optical channel width, or in this case, even the projectile diameter.

Also, it is noted that no attempt was made to homogenize the lateral sensitivity using a graded filter, e.g., 314. However, a simple test was performed to determine the feasibility of generating gray scale apertures using laser printed transparencies.

### Optical Diversity

An important aspect of the multi-beam approach, used by the ballistic detection systems 100, 200A is the ability to minimize cross-channel interference—the unintended injection of power from one channel 225 into a (usually) nearby channel 225. This can be addressed by using diversity in the detection channels. Diversity refers to differentiation between channels 225 that make interference less likely. The first diversity means is spatial diversity—if the optics 213A, 217A are sufficiently spatially isolated, e.g., collimated, focused, and aligned, then the light 221A from one channel will not enter the detector 218A of another. In cases where it is desired to push the detection range (e.g., size of detection area), then it will generally be the case that spatial diversity may not be sufficient. There are electrical means of introducing diversity into the detection channels 225 which are addressed below. Here we discuss other optical means of enabling diversity to enable independent operation of a large array of spatially close optical beam channels 225. These include:
Optical Wavelength—Narrow band NIR sources 212A that emit a specified wavelength, and are paired with detectors 218A sensitive to the same wavelength.
Polarization—Using polarization filters 214A, 216A channels 225 can operate on one of two independent polarization states. This creates of diversity factor of 2.

### Retroreflector

One innovative aspect of the approach, used by the ballistic detection system 100, is the use of a retroflector 150 to return transmitted optical beams 120, 121 towards their point of transmission 1100. This method, as mentioned above, has several advantages compared to separated point-point method:
Significantly reduces challenges of co-collimating separated Tx and Rx modules,
Retroreflectors 150 can be built very inexpensively,
Retroflection incurs limited costs in the beam pattern performance,
Retroreflectors 150 are low profile, lightweight, relatively insensitive to positioning and orientation which makes their deployment easy and unintrusive.

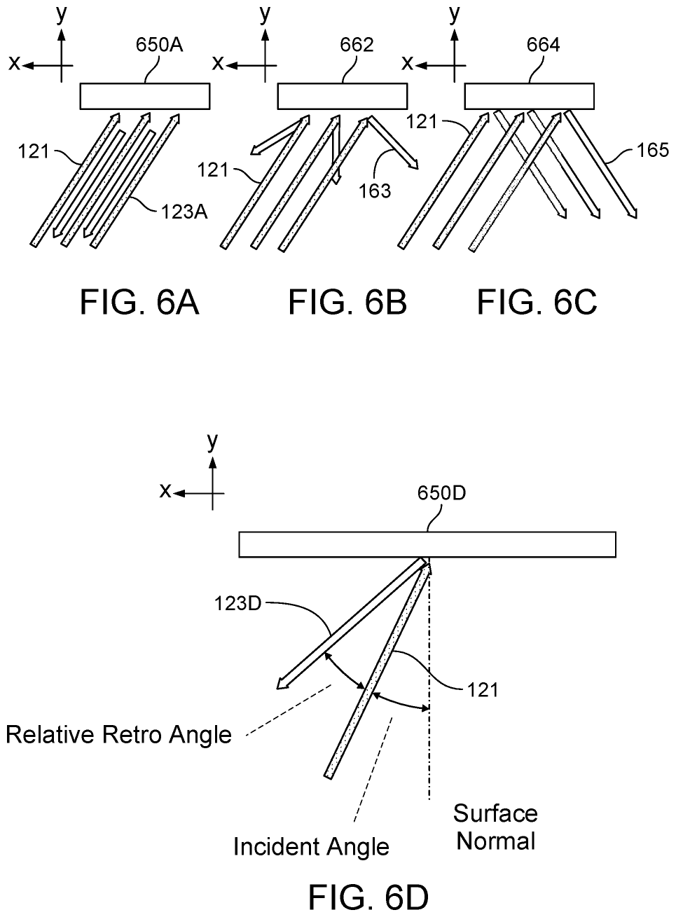

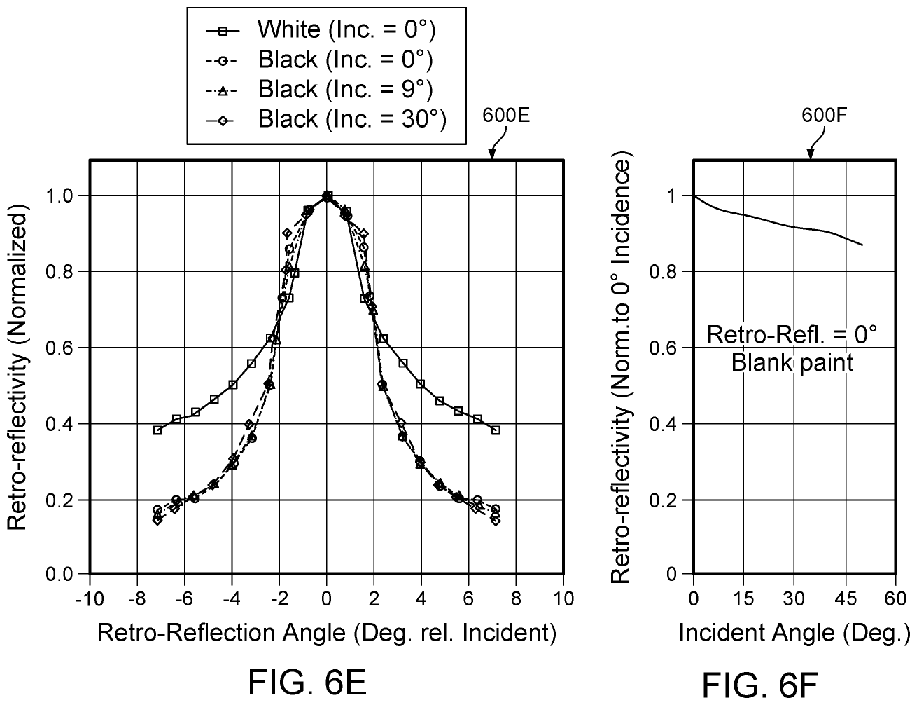

Retroflectors 150 have historically been based on one of two main approaches, either microspheres (beads) reflectors, e.g., retroreflector 650D shown in FIG. 6D, or pyramidal corner reflectors, generally referred to as ‘prismatic’, e.g., retroreflector 650A shown in FIG. 6A. FIG. 6A shows that the retroreflector 650A returns an incident collimated beam 121 as a reflected collimated beam 123A along a first direction that coincides with the incident direction. FIG. 6D shows that the retroreflector 650D returns an incident collimated beam 121 as a reflected collimated beam 123D along a second direction different from the incident direction. In contrast, a specular reflector 664, shown in FIG. 6C, reflects a collimated incident beam 121 as a reflected collimated beam 165 along a third direction that forms an angle relative to the incident direction that obeys the law of reflection. Or, a diffuse reflector 662, shown in FIG. 6B, reflects a collimated incident beam 121 as a reflected divergent beam 163 along the third direction.

While this field is extensively developed, the markets they largely serve are focused on safety with both strong retroreflectivity and wide-angle visibility. For the ballistic detection system 100, we seek retro-angle selectivity—e.g., a very narrow retroreflection cone angle that decreased rapidly from incidence. In general, microbead approaches are superior in working at large incident angles, and also, as shown in FIGS. 6E-6F, offer an opportunity to achieve narrow angles with high off-axis extinction.

A simple and well-suited means for the ballistic detection system 100 is the use of glass microspheres dispersed on the surface of a painted surface so as to cover the surface as completely as possible. Such microspheres are readily available, are inexpensive and easily applied. Substrate absorption significantly improves angular selectivity while simultaneously slightly increasing main (retro) beam gain. FIG. 6E is a graph 600E of normalized retro-reflectivity for small retro-reflection angles in the range of ±7°. FIG. 6F is a graph 600F of normalized retro-reflectivity for retro-reflection angles in the range of 0° to 50°.

The optical channels 225 of each of the ballistic detection systems 100, 200A, 200B provide the needed sensitivity to ballistic penetration across a wide range of projectiles, velocities, target dimensions.

### Multi-Traverse Beam Channel Configurations

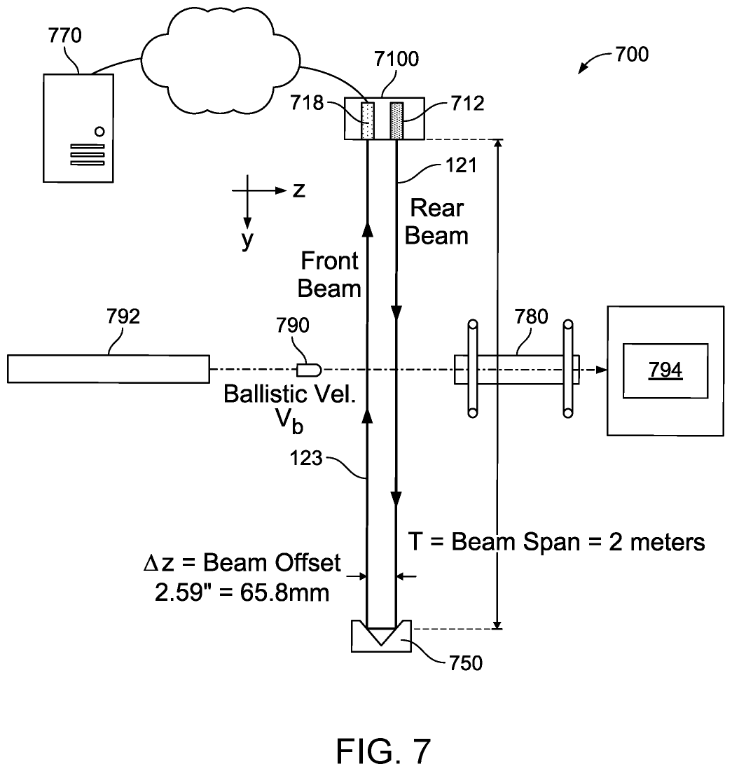

FIG. 7 shows an example of a multi-traverse beam ballistic detection system 700, which enables measurements of velocity and trajectory of a projectile 790. In the multi-traverse beam ballistic detection system 700, the outgoing beam 121 is folded back by a retroreflector 750 onto a parallel path offset by Δz, e.g., along the z-axis. This is done using a simple mirror corner reflector 750. This type of retroreflector 750 has two reflective surfaces oriented 90 degrees with respect to each other. The exact orientation of the retroreflector 750 with respect to the incoming beam 121 is not important as the outgoing beam 123 will be anti-parallel. A typical path separation Δz might be between 20 and 100 mm, or more, depending upon the application. Referring to FIG. 7, the position sensitive axis is perpendicular to the page; the long axis of the beam profile lies in this direction and the series of beams 121,123 are an array out of the plane as well.

The multi-traverse beam ballistic detection system 700 includes an array of transceivers TX/RX 7100 distributed along the x-axis, and separated from the retroreflector 750 along the y-axis by a beam span T. Each transceiver TX/RX 7100 has a TX which includes a light source 712, and a RX which includes a detector 718. The multi-traverse beam ballistic detection system 700 further includes a ballistics analysis computer 770 communicatively coupled with the detectors 718 of the array of transceivers TX/RX 7100. The ballistics analysis computer 770 is programmed to identify a location and a velocity of the projectile 790 as it passes through the detection area defined by the beams 121, 123, as explained below.

In the example shown in FIG. 7, the multi-traverse beam ballistic detection system 700 is used in conjunction with a muzzle 792 configured to shoot a projectile 790 along the z-axis through both outgoing beam 121 and returning beam 123 into a ballistic trap 794. Here, the multi-traverse beam ballistic detection system 700 includes a commercial ballistic chronograph 780 arranged along the trajectory of the projectile 790 to independently measure the projectile velocity.

With the multi-traverse beam ballistic detection system 700, we are able to measure two distinct modulations of the beam. The timing (Δt) provides projectile velocity, while modulation difference (ΔV) provides bullet trajectory. This is accomplished with no additional hardware compared to the system 100, except for a simple (2-surface) corner reflector 750. For our tests, we chose Δz˜66 mm (2.6 in.) beam offset. The beam span was T=2 meters for a total optical path of 4 meters. Using the multi-traverse beam ballistic detection system 700, a projectile 790 can pass through a specific optical beam twice. For this data, 22LR (nom. 5.5 mm) low velocity rounds (CCI Quiet) were used.

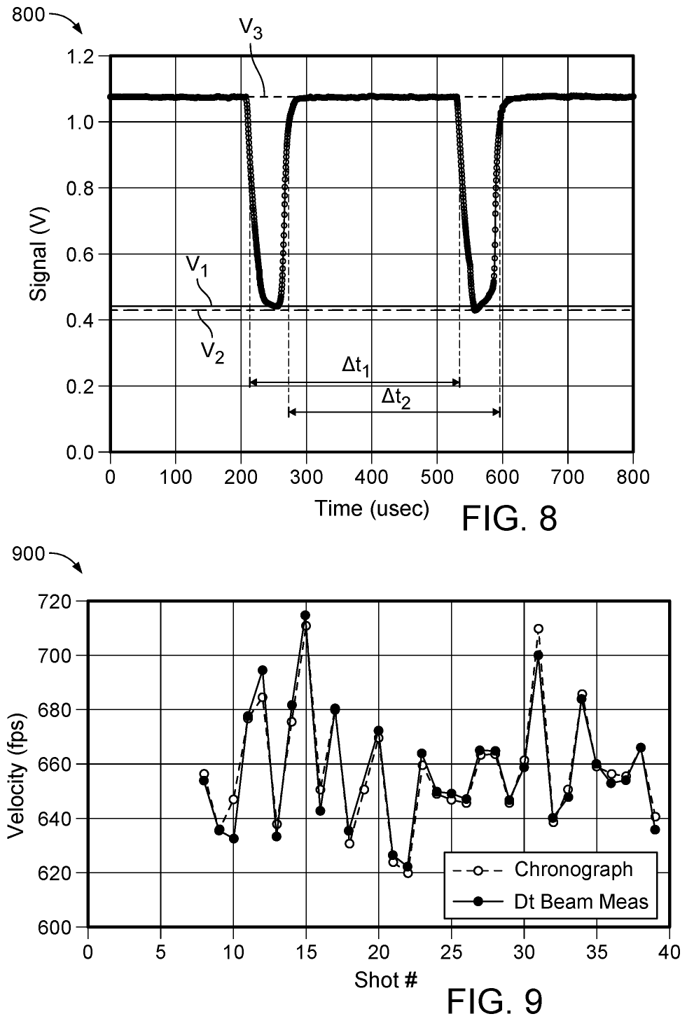

FIG. 8 is an oscilloscope trace 800 of optical beam signal from the projectile 790 passing through the double traverse beam 121/123. Using the falling edges of each shows a first time interval Δt₁=326.6 μsec, while the rising edges are separated by a second time interval Δt₂=322.4 μsec. Using the average time interval of Δt=324.5 μsec, and the measured beam offset of Δz=2.638″, the velocity is calculated to be 680.6 fps. The velocity determined by our collimated double traverse beam 121/123 is 680.6 fps compared with 681 fps measured by the chronograph 780.

FIG. 9 is a chart 900 showing comparison of the velocities of a set of shots measured in the manner described above and by a commercial chronograph 780 with a 12″ gage length. As mentioned above, the ammunition is low velocity 0.22 LR (CCI Quiet). The observed muzzle velocity of 660 fps is in line with product specs (710 fps). Besides the timing features, also observed in FIG. 8 is the fact that there are two distinct modulation depths indicated by the horizontal dashed line V₁ (1^{st} mod) and the horizontal dotted line V₂ (2^{nd} mod) as the projectile 790 passes through the beam twice 121/123. The modulation depth for each traverse is observed (horizontal dashed line V₁ & horizontal dotted line V₂ along with full signal average given by red dashed line V₃). For the data shown, the modulation depths of the first (up range beam path) and second (down range beam path) are 59.0% and 60.8% respectively. This provides the opportunity to make two distinct measurements of the projectile position separated by a distance equal to the beam offset parameter Δz. In the data above, we arranged the beam and rifle bore to be approximately parallel to each other so that the modulation depths should be approximately equal, V₁≈V₂, so the modulation difference is about zero, ΔV≈0. As we stepped the rifle position across the beams in 0.010″ (0.25 mm) steps, it was expected and observed that the modulation depths tracked each other. Note that the first 7 shots in graph 900 are not shown because projectile 790 is outside of the beam 121/123 for those shots.

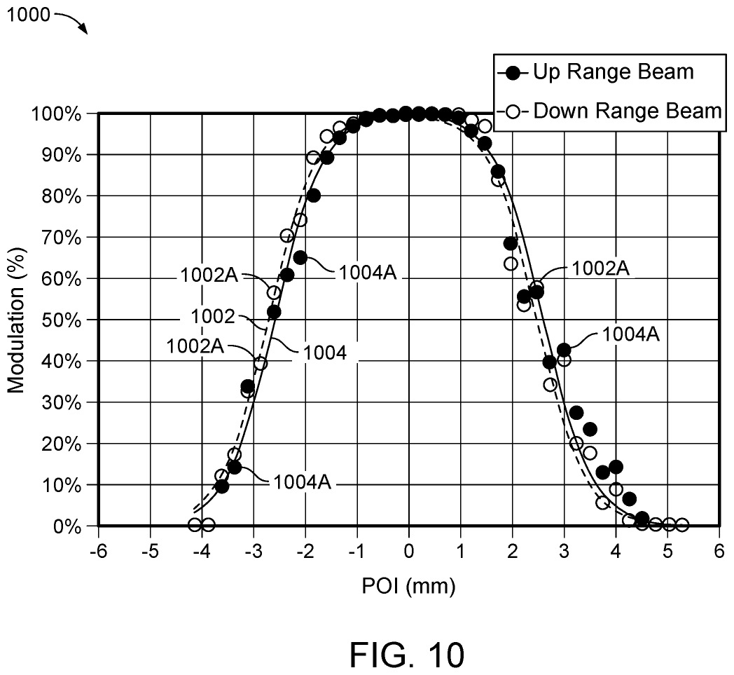

FIG. 10 is a graph 1000 of modulation depth versus virtual point of impact. A virtual point of impact is an impact point on a virtual plane. To obtain graph 1000, a gun was translated in steps, keeping its barrel orientation parallel, so that the muzzle position corresponds to the virtual point of impact, with all measurements using parallel ballistic trajectories. As can be seen, the two sets of modulation depths plotted versus virtual point of impact track each other very closely. The dashed lines 1002, 1004 are fits to the respective data points 1002A, 1004A. From the fits in graph 1000, we determine that the downrange beam 121 is shifted 0.1 mm to left of the up-range beam 123.

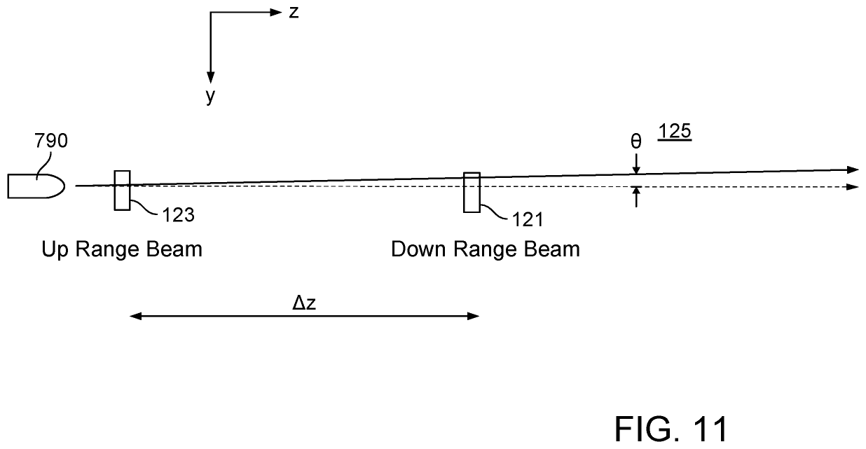

FIG. 11 shows the projectile's 790 trajectory tilted by an angle θ 125 with respect to the beams 121, 123. The angle of incidence for the incoming round 790 is intentionally modified by raising one edge of the rifle platform. The measured angle increase was 0.9 degrees. Signals were detected when the projectile 790 transited each beam 121, 123 at different relative levels.

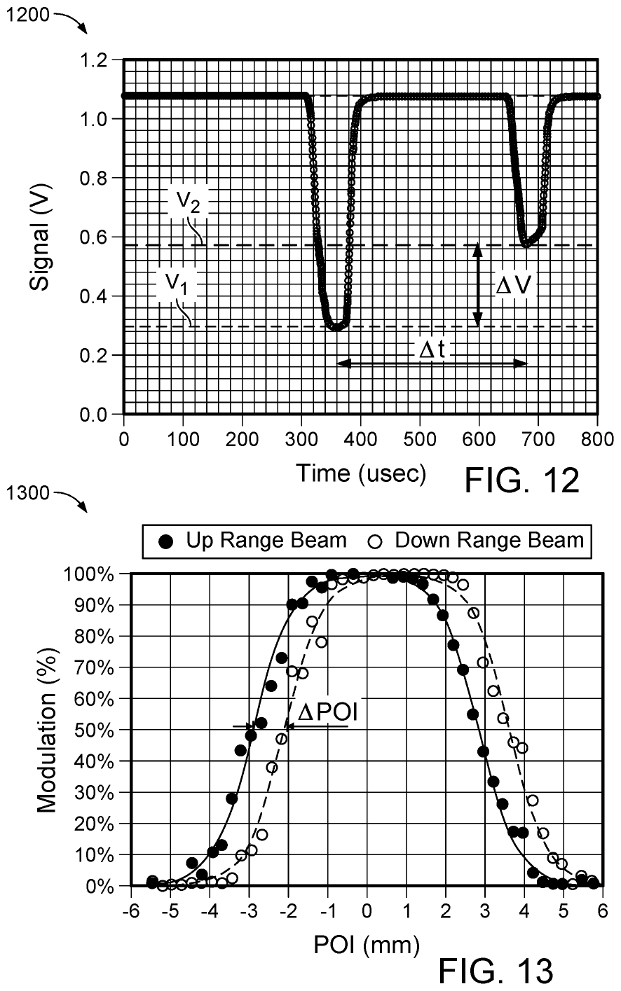

FIG. 12 is a graph 1200 of an example of a signal detected when the projectile 790 transits each beam 121, 123 at different relative levels. The difference between the levels Δy is proportional to a difference ΔV between the modulation depth of the two traverses indicated by the horizontal dashed line V₁ and the horizontal dotted line V₂. The velocity of the projectile 790 is calculated using the time interval Δt measured from graph 1200, and the measured beam offset Δz in FIG. 7 or FIG. 11.

A series of shots were fired using this rifle angle 125. FIG. 13 is a graph 1300 of two sets of modulation curves for a series of shots fired using the rifle angle 125. The shift ΔPOI of the two curves illustrated in graph 1300 is related to the projectile incident angle 125. Again, the dashed lines are fits to the data. From these, we can determine the relative shift compared to the previous data (nominal zero-degree angle). We measure the shift to be ΔPOI=0.90 mm. Since the beam offset is 64 mm, the measured angle shift is 0.8 degrees (48 MOA), in close agreement with the known angle shift 0.9 degrees (54 MOA). Thus, we see that the disclosed technology has the capability of measuring trajectory angles with precision. The data indicates that better than 0.5 degree (30 MOA) should be achievable.

Analysis/System Integration: Methods and algorithms for determining projectile penetration, caliber, and velocity are provided. Because projectile velocity and length also factor into the determination of expected signal, these parameters can be suitably handled. An optical detection method using the proposed system can employ ratiometric measurements—ratios of signals on adjacent channels—used to uniquely determine the POI.

Prototype: The initial prototype system focuses on demonstrating at a small scale on the essentials of the system described herein, including optics, electronics, and performance metrics. It included two crossed arrays of multiple optical channels—e.g., 64 per module. For the optical system, a housing to accommodate the optical elements can be fabricated. Further, a molded monolithic lens can be used.

In addition to military and police use, the described systems and techniques, including NIR free space detection system technology, can be used for a number of applications, including as a commercial target system for recreational and competitive shooting sports. Such non-contact ballistic impact detection systems can provide at least 1 m² of coverage area, detect and locate small caliber rounds (e.g., 5.56 mm and larger) traveling up to 1000 m/s (3300 fps) with an accuracy of 5 mm. They can also determine the velocity with an accuracy of at least 2%, and estimate the caliber to within 10%. The detection/reset time can be no more than 20 msec, support a ROF up to 40 rps (2400 rpm). The hardware can be modular, with linear array sections that can be joined end to end to build longer arrays. The maximum range to the retroreflectors can be at least 10 meters (33 ft). Moreover, such systems can achieve various performance goals, including:

Adequate optical signal

Good optical spatial sensitivity

Channel-channel isolation of >20 dB can be achieved for large arrays

Integration with other systems, including interface with conventional networks.

Detection of live fire on real-world ranges.

The described technology can be used in a commercial electronic target system for both competitive and recreational civilian use, and as an automated system for shooting skills qualification of law enforcement and other professionals.

Shooting sports are a widely enjoyed recreational and competitive activities that embrace many forms of marksmanship. Both recreational shooting as well as organized disciplines would benefit from a low cost, adaptable electronic point-of-impact/scoring system. Adaptability is an important attribute of such a technology as it should support and be scalable to such diverse applications as 1000 yard F-class centerfire, rimfire benchrest at 50 yards, Bullseye pistol at 25 and 50 yards, or 10 meter air rifle/pistol.

A precise, real-time target system would have many benefits. It would enable more precise scoring with much less manual effort, allow for greater spectator involvement and excitement, and lead to increasing popularity. A precise and low cost system would allow smaller clubs, ranges, and individuals to access precise and real-time shot placement information for sighting in, load development, testing and characterization, practice, and informal or local competitions. In turn these lead to greater interest and growth of the shooting sports with follow-on advancements in equipment and techniques. Law enforcement training and qualification can benefit by better and automated shot location detection. Greater enjoyment of shooting benefits civilian marksmanship, promotes stewards of safety and advocacy, advances a camaraderie that enhances the family environment, and increases the confidence, self-discipline, and self-esteem of youth.

What is claimed is:

1. A ballistic detection system comprising:
one or more light sources configured to transmit collimated light through a detection area;
a receiver array arranged with respect to the detection area to receive the collimated light in multiple side-by-side channels, the receiver array comprising (i) light detectors corresponding to the multiple side-by-side channels, and (ii) lenses arranged to focus respective portions of the collimated light, which has transited the detection area, onto respective ones of the light detectors corresponding to the multiple side-by-side channels; and
a ballistics analysis computer coupled with the receiver array and programmed to identify a location of a projectile that passes through the detection area by performing ratiometric comparison of signal data from the light detectors, the signal data corresponding to fractional blockage, by the projectile, of the collimated light in one or more of the multiple side-by-side channels.

2. The ballistic detection system of claim 1, wherein the lenses comprise a single monolithic lens array.

3. The ballistic detection system of claim 2, wherein the single monolithic lens array is formed using molded plastic.

4. The ballistic detection system of claim 1, wherein the one or more light sources comprise a transmitter array comprising multiple light emitters, and the transmitter array is configured to transmit the collimated light as a set of multiple collimated light beams.

5. The ballistic detection system of claim 4, comprising a one-to-one correspondence between the light emitters and the light detectors.

6. The ballistic detection system of claim 5, wherein the light emitters comprise narrowband or monochromatic light emitters comprising two or more separate wavelength bands or colors, and each of the light detectors has an associated narrow passband filter in front of the light detector that restricts sensitivity of the light detector to the narrowband or monochromatic light produced by that light detector's corresponding light emitter.

7. The ballistic detection system of claim 6, wherein each of the light emitters comprises a near infrared light emitting diode or a visible light emitting diode.

8. The ballistic detection system of claim 6, wherein the light emitters are arranged to alternately direct the multiple collimated light beams into respective ones of two columns that are offset from each other in a direction of the projectile's motion, wherein a width of each of the multiple collimated light beams is greater than a channel-to-channel spacing of the multiple side-by-side channels, thereby causing the side-by-side channels to overlap with each other, the light detectors are alternately positioned in respective ones of the two columns, and the ballistics analysis computer is programmed to identify the location of the projectile that passes through the detection area by performing ratiometric comparison of the signal data corresponding to fractional blockage, by the projectile, of the collimated light in two or more of the multiple side-by-side channels.

9. The ballistic detection system of claim 4, wherein the transmitter array is configured to generate the multiple collimated light beams in the multiple side-by-side channels with different combinations of wavelength and polarization to isolate the multiple side-by-side channels from each other, reduce any cross-talk between channels, and reduce sensitivity to any ambient sources.

10. The ballistic detection system of claim 4, wherein the transmitter array is configured to generate the multiple collimated light beams in the multiple side-by-side channels using different modulation phase and/or frequency modulation techniques to isolate the channels from cross-talk.

11. The ballistic detection system of claim 4, wherein
each of the one or more light sources is a pulsed light source that is triggered by a projectile detector, and
the projectile detector is configured to provide wide field of view detection of the projectile, initiate time-of-flight measurement, and trigger the pulsed light sources.

12. The ballistic detection system of claim 11, wherein the projectile detector comprises a conventional ballistic chronograph.

13. The ballistic detection system of claim 4, wherein
the detection area is a first detection area,
the system comprises a retroreflector configured and arranged to fold the multiple collimated light beams back onto a parallel but offset path, thereby forming a second detection area offset from the first detection area along a direction of travel of the projectile, and
the ballistics analysis computer is programmed to determine a magnitude and direction of a velocity vector of the projectile, the velocity magnitude determined by measuring a time offset between a pair of modulations in the signal data, and the velocity direction by measuring a relative size of the modulations of the pair.

14. The ballistic detection system of claim 13, wherein the retroreflector comprises a corner reflector comprised of two reflecting surfaces with surfaces at right angles to each other.

15. The ballistic detection system of claim 13, comprising a set of filters configured to tailor an intensity profile of the collimated light in a least a portion of the multiple side-by-side channels.

16. The ballistic detection system of claim 13, wherein the ballistics analysis computer is programmed to determine the velocity magnitude by dividing an actual distance traveled by the time offset, wherein the actual distance traveled is a perpendicular spacing between the first and second detection areas divided by cosine of an angle of the velocity direction.

17. The ballistic detection system of claim 13, wherein the one or more light sources comprise a transmitter array comprising narrowband or monochromatic light emitters comprising two or more separate wavelength bands or colors, each of the light detectors has an associated narrow passband filter in front of the light detector that restricts sensitivity of the light detector to the narrowband or monochromatic light produced by that light detector's light emitter, the transmitter array is configured to transmit the collimated light as a set of multiple collimated light beams, the light emitters are arranged to alternately direct the multiple collimated light beams into respective ones of two columns that are offset from each other in a direction of the projectile's motion in the first detection area, wherein a width of each of the multiple collimated light beams is greater than a channel-to-channel spacing of the multiple side-by-side channels, thereby causing the side-by-side channels to overlap with each other, the light detectors are alternately positioned in respective ones of two corresponding columns in the second detection area offset from the first detection, and the ballistics analysis computer is programmed to identify the location of the projectile that passes through the first and second detection areas by performing ratiometric comparison of the signal data corresponding to fractional blockage, by the projectile, of the collimated light in two or more of the multiple side-by-side channels.

18. The ballistic detection system of claim 1, wherein the one or more light sources comprise
a first light source configured to transmit the collimated light as first collimated light through the detection area along a first direction, and
a second light source configured to transmit second collimated light through the detection area along a second direction,
wherein the first direction crosses the second direction;
wherein the receiver array is a first receiver array, the multiple side-by-side channels are first multiple side-by-side channels, and the system comprises
a second receiver array arranged with respect to the detection area to receive the second collimated light in multiple second side-by-side channels, the second receiver array comprising (i) light detectors corresponding to the multiple second side-by-side channels, and (ii) lenses arranged to focus respective portions of the second collimated light, which has transited the detection area, onto respective ones of the light detectors corresponding to the multiple second side-by-side channels; and
wherein the ballistics analysis computer is coupled with the second receiver array and is programmed to identify the location of the projectile as both an X position and a Y position of the projectile in the detection area.

19. The ballistic detection system of claim 18, wherein the first light source, the second light source, the first receiver array, and the second receiver array are all co-sited in an electro-optic housing located on a first side of a target, and the system comprises a retroreflector located on a second side of the target, opposite the first side.

20. The ballistic detection system of claim 18, wherein the first light source comprises a first transmitter array comprising narrowband or monochromatic light emitters comprising two or more separate wavelength bands or colors, the second light source comprises a second transmitter array comprising narrowband or monochromatic light emitters comprising the two or more separate wavelength bands or colors, each of the light detectors has an associated narrow passband filter in front of the light detector that restricts sensitivity of the light detector to the narrowband or monochromatic light produced by that light detector's light emitter, the first transmitter array is configured to transmit a first set of multiple collimated light beams in respective ones of two columns that are offset from each other in a direction of the projectile's motion, the second transmitter array is configured to transmit a second set of multiple collimated light beams in respective ones of two columns that are offset from each other in the direction of the projectile's motion, wherein a width of each of the multiple collimated light beams is greater than a channel-to-channel spacing, thereby causing the side-by-side channels to overlap with each other, the light detectors are alternately positioned in respective ones of two columns, and the ballistics analysis computer is programmed to identify the location of the projectile as both the X position and the Y position of the projectile in the detection area by performing ratiometric comparison of the signal data corresponding to fractional blockage, by the projectile, of the collimated light in four or more of the multiple side-by-side channels.
